(19) United States
(12) Patent Application Publication
(10) Pub. No.: US 2019/0369236 A1
(43) Pub. Date: Dec. 5, 2019

(54) METHOD FOR OPERATING A LOUDSPEAKER UNIT, AND LOUDSPEAKER UNIT

(71) Applicant: USound GmbH, Graz (AT)

(72) Inventors: Andrea Rusconi Clerici Beltrami, Wien (AT); Ferruccio Bottoni, Graz (AT)

(21) Appl. No.: 16/426,594

(22) Filed: May 30, 2019

(30) Foreign Application Priority Data
Jun. 1, 2018 (DE) 10 2018 113 112.7

(51) Int. Cl. G01S 15/08; H04R 19/02; H04R 19/04; H04R 3/04; G01S 15/89

(52) U.S. Cl. CPC G01S 15/08; H04R 19/02; H04R 19/04; H04R 3/04; G06F 3/017; H04R 2201/003; H04R 2400/01; H04R 2201/028; G01S 15/89

(57) ABSTRACT

A method is provided for operating a loudspeaker unit for a portable device, in which sound waves in the audible wavelength range are generated and/or detected with the aid of a MEMS sound transducer. A control unit of the loudspeaker unit operates MEMS sound transducer as an ultrasonic proximity sensor that generates and detects ultrasonic waves to measure a distance between itself and an object. The invention also relates to a loudspeaker unit that includes a control unit for operating a MEMS sound transducer that generates and/or detects sound waves in the audible wavelength range so as to measure a distance between itself and an object.

### FIELD OF THE INVENTION

The present invention relates to a method for operating a loudspeaker unit, in particular for a portable device, in which sound waves in the audible wavelength range are generated and/or detected with the aid of a MEMS sound transducer of the loudspeaker unit. The present invention also relates to a loudspeaker unit, in particular for a portable device, comprising a MEMS sound transducer for generating and/or detecting sound waves in the audible wavelength range.

### BACKGROUND OF THE INVENTION

A loudspeaker array comprising a MEMS sound transducer for generating and/or detecting sound waves in the audible wavelength spectrum is known from applicant's US Patent Application Publication No. 2018-0234783, which is hereby incorporated herein by this reference for all purposes.

### BRIEF OBJECTS AND SUMMARY OF THE INVENTION

An object of the present invention is therefore to improve the related art.

The object is achieved by means of a method for operating a loudspeaker unit, and a loudspeaker unit having the features described herein.

The invention relates to a method for operating a loudspeaker unit, wherein the loudspeaker unit can be arranged, for example, in a portable device. The portable device can be, for example, a smartphone, a tablet, a laptop, or the like, with the aid of which, for example, music, tones, and/or speech can be generated. In the method, sound waves in the audible wavelength range are generated with the aid of a MEMS sound transducer of the loudspeaker unit. The audible wavelength range for the human ear begins at approximately 20 Hz in the lower range and extends to approximately 20 kHz in the upper range. Sound waves having a lower or higher frequency cannot be perceived by the human ear. The abbreviation MEMS stands for micro-electromechanical systems. The MEMS sound transducer can therefore be utilized as a loudspeaker. Additionally or alternatively, in the method, sound waves in the audible wavelength range can also be detected with the aid of the MEMS sound transducer. The MEMS sound transducer can therefore be utilized as a microphone.

According to the invention, the MEMS sound transducer is additionally operated as an ultrasonic proximity sensor by a control unit of the loudspeaker unit. The MEMS sound transducer can therefore be operated for generating and/or detecting sound waves in the audible wavelength range and can be operated as an ultrasonic proximity sensor. Due to the utilization of only one MEMS sound transducer, the loudspeaker unit can be designed in a more space-saving and more cost-effective manner.

In the method, ultrasonic waves are generated and detected with the aid of the MEMS sound transducer in order to measure a distance between itself and an object. With the aid of the MEMS sound transducer as an ultrasonic proximity sensor, the loudspeaker unit can measure the distance, for example, in that a test signal consisting of ultrasonic waves is emitted. The test signal consisting of ultrasonic waves is reflected on an object arranged in front of the MEMS sound transducer and at least a portion of the test signal returns to the MEMS sound transducer, with the aid of which the object is detected. The distance between the MEMS sound transducer and the object can be determined on the basis of the time between the emission and the reception of the test signal. With the aid of the distance measurement, for example, power-off functions and/or wake-up functions can be implemented. If the loudspeaker unit or the portable device comprising the loudspeaker unit is touched or if the hand approaches, this can be detected with the aid of the distance measurement between the hand and the loudspeaker unit or the portable device. The portable device can be subsequently activated, so that the user can utilize the device immediately. If the user sets the device down again, this can be detected with the aid of the distance measurement and the device can be powered off again.

Since the distance measurement is carried out with the aid of the ultrasonic waves, the music, the tones, and/or the speech are/is not adversely affected, since the ultrasonic waves are not perceptible by the human ear. With the aid of the loudspeaker unit, music, for example, can therefore be heard, wherein the distance to the object is simultaneously measured, without the user noticing this.

In an advantageous enhanced embodiment of the invention, the MEMS sound transducer is operated as a loudspeaker during a loudspeaker interval. The loudspeaker interval is a time interval, during which the MEMS sound transducer is operated as a loudspeaker. Therefore, sound waves are generated in the loudspeaker interval.

Additionally or alternatively, the MEMS sound transducer is operated as a microphone during a microphone interval, which is time-shifted with respect to the loudspeaker interval. The microphone interval is a time interval, during which the MEMS sound transducer is operated as a microphone. Therefore, sound waves can be detected. The microphone interval can be arranged, for example, before the loudspeaker interval with respect to time, so that, first of all, the sound waves can be detected and, thereafter, the sound waves are generated during the loudspeaker interval. Additionally or alternatively, the microphone interval can also be arranged after the loudspeaker interval with respect to time, so that, first of all, the sound waves are generated and, thereafter, sound waves are detected. The sound waves generated during the loudspeaker interval can encompass the test signal. The sound waves encompassing the reflected test signal can be detected during the microphone interval. The distance between the MEMS sound transducer and the object can be determined from the time difference between the generation of the test signal and the detection of the test signal.

Due to the temporal separation of the loudspeaker interval, in which the sound waves are generated, and the microphone interval, in which the sound waves are detected, the MEMS sound transducer can generate and detect the sound waves with a higher sound quality.

Advantageously, the loudspeaker interval and the microphone interval can alternate. As a result, the distance between the MEMS sound transducer and the object can be measured repeatedly, which is advantageous, for example, when the distance between the MEMS sound transducer and the object changes, so that a distance change can be measured.

It is advantageous if the MEMS sound transducer generates the audible sound waves during the loudspeaker interval, in a sound interval. In the sound interval, the MEMS sound transducer can therefore generate, for example, speech, music, or tones.

The MEMS sound transducer can generate the ultrasonic waves in the loudspeaker interval, in an ultrasound interval, which is time-shifted with respect to the sound interval. In the ultrasound interval, the MEMS sound transducer can therefore be utilized in such a way that it is operated as an ultrasonic proximity sensor.

Advantageously, the sound interval and the ultrasound interval can alternate at least once. The sound interval and the ultrasound interval can therefore alternate at least once in the loudspeaker interval.

Furthermore, it is advantageous if the ultrasonic waves for measuring the distance and the sound waves of the audible wavelength range are generated simultaneously. Since the ultrasonic waves for measuring the distance can lie in a frequency range of, for example, 40 kHz to 150 kHz, the ultrasonic waves are not perceptible by the human ear, so that, in the case of simultaneous generation of ultrasonic waves and the sound waves of the audible wavelength range, there is no adverse effect on the music, the tones, and/or the speech. As a result, the distance between the object and the MEMS sound transducer can be continuously measured. The ultrasonic waves can be modulated, for example, onto the sound waves of the audible wavelength range, which encompass the music, the tones, and/or the speech. As a result, the sound waves of the audible wavelength range and the ultrasonic waves can be generated simultaneously.

It is also advantageous if the loudspeaker unit includes at least one loudspeaker amplifier, which processes an audio signal and sends the audio signal to the MEMS sound transducer at least during the loudspeaker interval. With the aid of the loudspeaker amplifier, the audio signal can be amplified, for example, so that it can be converted into sound waves at the MEMS sound transducer. Additionally or alternatively, the loudspeaker amplifier can also modify the audio signal in such a way that the MEMS sound transducer generates a provided tone signal for this purpose. Since the loudspeaker amplifier can only amplify and/or process the audio signal, it can be designed and optimized for this purpose

It is likewise advantageous if the loudspeaker unit includes at least one microphone amplifier, which, at least during the microphone interval, receives an acoustic signal from the MEMS sound transducer and processes the acoustic signal. The microphone amplifier can receive and process, in particular, speech, tones, or music from the MEMS sound transducer. Additionally or alternatively, the microphone amplifier can also receive the test signal reflected by the object, so that the distance between the MEMS sound transducer and the object can be calculated on the basis thereof. Since the microphone amplifier only amplifies and/or processes the acoustic signal, it can be designed and optimized for this purpose.

Advantageously, a sound signal contained in the acoustic signal can be received and amplified by a first microphone amplifier, and a distance signal contained in the acoustic signal can be received and amplified by a second microphone amplifier. The distance signal can be, for example, the reflected test signal, which was emitted by the MEMS sound transducer for the distance measurement and was reflected on the object. Due to the fact that the loudspeaker unit comprises two microphone amplifiers, each microphone amplifier can be specialized for its task. The first microphone amplifier can be utilized for amplifying and processing the sound signals, which encompass, in particular, music, tones, and/or speech and, therefore, lie in the audible wavelength range.

The second microphone amplifier can be utilized for amplifying and processing the distance signal, which lies in the ultrasonic range.

Since the distance signal lies in the ultrasonic range and the sound signal lies in the audible wavelength range, the distance signal has a higher frequency than the sound signal. After the distance signal and the sound signal have been detected by the MEMS sound transducer, the associated electrical signals likewise have a different frequency. The electrical signal associated with the distance signal likewise has a higher frequency than the electrical signal associated with the sound signal. It is advantageous if the loudspeaker unit comprises a frequency-separating filter, which filters the sound signal out of the acoustic signal and sends it to the first microphone amplifier. Additionally or alternatively, the frequency-separating filter can filter the distance signal out of the acoustic signal and send it to the second microphone amplifier. The frequency-separating filter can also separate the sound signal from the distance signal, so that the sound signal can be conducted to the first microphone amplifier and the distance signal can be conducted to the second microphone amplifier.

It is advantageous if the sound signal is conducted from the first microphone amplifier to a first processor, which digitizes and/or filters the sound signal. Additionally or alternatively, the distance signal can be conducted from the second microphone amplifier to a second processor, which digitizes and/or filters the distance signal. As a result, the sound signal and/or the distance signal can be conditioned for further processing. For example, the sound signal can be stored in a memory or transmitted via the Internet or a similar transmission path, which, for example, is commonly used for making telephone calls. The distance signal can be further processed in such a way that the distance between the MEMS sound transducer and the object can be determined.

It is advantageous if the control unit controls a switching unit of the loudspeaker unit in such a way that a connection is established between the loudspeaker amplifier and the MEMS sound transducer during the loudspeaker interval. As a result, malfunctions can be prevented. For example, the situation is prevented in which sound waves are detected and transmitted to a microphone amplifier during the loudspeaker interval of the MEMS sound transducer.

Additionally or alternatively, it is advantageous if a connection is established between the MEMS sound transducer and the at least one microphone amplifier during the microphone interval. As a result, the situation is prevented in which sound waves are generated by the MEMS sound transducer during the microphone interval.

It is advantageous if a cycle time of the loudspeaker interval and of the microphone interval together lasts for between 0.1 μs (microsecond) and 20 ms (milliseconds). The cycle time can also last for between 0.5 μs and 5 ms. As a result, the MEMS sound transducer can be operated for a sufficiently long time as a loudspeaker and/or as a microphone.

Additionally or alternatively, it is advantageous if the duration of the loudspeaker interval has a ratio with respect to the duration of the microphone interval between 0.2 and 5000. The ratio is the duration of the loudspeaker interval divided by the duration of the microphone interval. The ratio can also be between 0.2 and 2500, however. The ratio can also be 1, however, so that the duration of the loudspeaker interval and the duration of the microphone interval are equal. As a result, a switch between the loudspeaker interval and the microphone interval can be carried out sufficiently quickly. High ratios, for example, 1000, can arise when the loudspeaker unit is utilized mainly for generating music, tones, and/or speech and only short sound waves are detected during the microphone interval. The MEMS sound transducer is operated, for example, only briefly as a microphone, in order, for example, to be able to detect whether the user of the loudspeaker unit has begun speaking, as the user, for example, has given a speech command or has begun telephoning when the loudspeaker unit is arranged, for example, in a smartphone. If no speech has been detected, a switch back into the loudspeaker interval can take place, wherein, for example, the ratio of 1000 is retained. However, if speech has been detected, the ratio, for example, of 1000, can be reduced, so that the microphone interval is extended. The microphone can also be activated for the purpose of being able to detect ultrasonic waves reflected by the object, in order to determine the distance.

It is also advantageous if the MEMS sound transducer is operated as a microphone, between the operation as a loudspeaker, only for as long as it takes for the impression to arise that the MEMS sound transducer is operated continuously as a loudspeaker.

It is advantageous if the duration of the sound interval with respect to the duration of the ultrasound interval has a ratio between 10 and 5000. The ratio can also be between 50 and 2500, however. The ratio is the duration of the sound interval divided by the duration of the ultrasound interval. Since the ultrasound is generated during the ultrasound interval, and the ultrasound has a frequency that is high as compared to audible sound, the ultrasound interval can have a correspondingly shorter duration. In addition, during the ultrasound interval, only the test signal is generated for measuring the distance between the MEMS sound transducer and the object. In order to measure distance, it suffices to transmit a relatively short test signal as compared to generating the audible sound waves, transmitting the music, tones, or speech.

It is advantageous if such ultrasound is generated with the aid of the MEMS sound transducer that a haptic perception is formed with the aid of the ultrasonic waves. The perception of an object can therefore be formed with the aid of the ultrasonic waves. The ultrasonic waves can be radiated, for example, in one direction and/or modulated in such a way that a push and/or a pull, for example, onto a hand of a user of the loudspeaker unit, is formed. As a result, the user can perceive the object generated with the aid of the ultrasonic waves. Such a method is referred to as ultrahaptics,

It is also advantageous if the distance signal is evaluated with the aid of an evaluation unit, so that a distance profile is determined. On the basis of the distance profile, for example, a shape of the object, the distance to which is measured, is determined. Additionally or alternatively, gestures can be recognized. As a result, for example, a swiping movement of a user can be perceived, in order to carry out an action. If the loudspeaker unit is arranged, for example, in a smartphone, the smartphone can be activated with the aid of the recognition of the gesture. On the basis of the distance profile, it can also be determined, for example, that the smartphone is being moved toward an ear of the user, so that functions of the smartphone and, in particular, of the loudspeaker unit can be adjusted in such a way that the smartphone can be utilized as a telephone.

Furthermore, the invention relates to a loudspeaker unit, which can be utilized, for example, for a portable device. The loudspeaker unit comprises a MEMS sound transducer for generating sound waves in the audible wavelength range. The MEMS sound transducer can therefore be operated as a loudspeaker. Additionally or alternatively, the MEMS sound transducer can also detect sound waves in the audible wavelength range, so that the MEMS sound transducer can be operated as a microphone.

In this case, the MEMS sound transducer can be designed in such a way that, in addition, sound waves in the ultrasonic range can be generated and detected with the aid of the MEMS sound transducer.

Furthermore, the loudspeaker unit comprises a control unit, with the aid of which the MEMS sound transducer can be operated as an ultrasonic proximity sensor according to one or multiple method steps of the preceding description and/or the following description.

With the aid of the MEMS sound transducer, a distance between itself and an object in the surroundings of the loudspeaker unit can therefore be determined.

### BRIEF DESCRIPTION OF THE DRAWINGS

Additional advantages of the invention are described in the following exemplary embodiments. The drawings show in:

FIG. 1 shows a block diagram of a loudspeaker unit,

FIG. 2 shows a block diagram of an alternative exemplary embodiment of a loudspeaker unit, and

FIG. 3 shows a timing diagram of the operating conditions of the loudspeaker unit.

### DESCRIPTION OF EXEMPLARY EMBODIMENTS OF THE INVENTION

Reference will now be made in detail to present exemplary embodiments of the invention, wherein one or more examples of which are illustrated in the accompanying drawings. The detailed description uses numerical and letter designations to refer to features in the drawings. Like or similar designations in the drawings and description have been used to refer to like or similar parts of the embodiments of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

It is to be understood that the ranges and limits mentioned herein include all sub-ranges located within the prescribed limits, inclusive of the limits themselves unless otherwise stated. For instance, a range from 100 to 200 also includes all possible sub-ranges, examples of which are from 100 to 150, 170 to 190, 153 to 162, 145.3 to 149.6, and 187 to 200. Further, a limit of up to 7 also includes a limit of up to 5, up to 3, and up to 4.5, as well as all sub-ranges within the limit, such as from about 0 to 5, which includes 0 and includes 5 and from 5.2 to 7, which includes 5.2 and includes 7. Moreover, while specific spatial dimensions are provided for some of the exemplary embodiments described herein, the present invention is not limited to embodiments with those specific spatial dimensions.

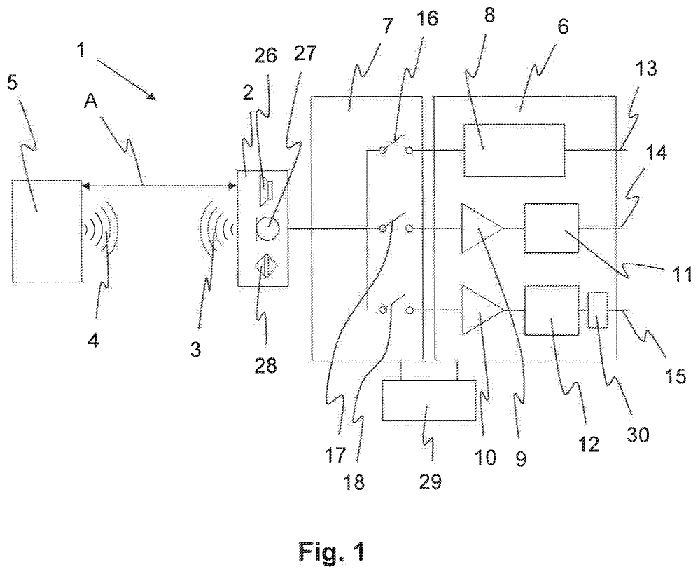

FIG. 1 shows a block diagram of a loudspeaker unit 1. The loudspeaker unit 1 comprises a MEMS sound transducer 2, with the aid of which sound waves 3, 4 can be generated and detected during the operation of the loudspeaker unit 1. The loudspeaker unit 1 can therefore be a sound transducer unit. The loudspeaker unit 1 can be arranged, for example, in a portable device, such as a smartphone, a tablet, or the like, in order to be able to play back music, speech, or tones. The MEMS sound transducer 2 can therefore be operated as a loudspeaker 26. With the aid of the MEMS sound transducer 2, speech, tones, or music can also be recorded, however, so that the MEMS sound transducer 2 is operated as a microphone 27. With the aid of the loudspeaker unit 1, for example, in a smartphone, it is therefore possible, for example, to make a telephone call.

Furthermore, the MEMS sound transducer 2 can be additionally operated as an ultrasonic proximity sensor 28 in order to be able to measure a distance A between itself and an object 5. For this purpose, the MEMS sound transducer 2 can emit ultrasonic waves, which are reflected by the object 5 and return to the MEMS sound transducer 2, with the aid of which the ultrasonic waves are detected. On the basis of the propagation time of the ultrasonic waves, the distance A between the object 5 and the MEMS sound transducer 2 can be determined.

According to the present exemplary embodiment, the loudspeaker unit 1 comprises a processing unit 6, which can condition, for example, an audio signal for the MEMS sound transducer 2 for playback. Additionally or alternatively, the processing unit 6 can also condition the sound waves detected by the MEMS sound transducer 2.

Furthermore, the loudspeaker unit 1 comprises a loudspeaker amplifier 8. In the present exemplary embodiment from FIG. 1, the loudspeaker amplifier 8 is arranged in the processing unit 6. With the aid of the loudspeaker amplifier 8, the audio signal intended for output at the MEMS sound transducer 2 can be amplified and/or processed.

Furthermore, the loudspeaker unit 1 can comprise at least one microphone amplifier 9, 10. With the aid of the at least one microphone amplifier 9, 10, the sound waves detected by the MEMS sound transducer 2 can be amplified and/or processed. In the exemplary embodiment from FIG. 1, the at least one microphone amplifier 9 is arranged in the processing unit 6.

According to the present exemplary embodiment, the loudspeaker unit 1 comprises a first microphone amplifier 9 and a second microphone amplifier 10. One of the two microphone amplifiers 9, 10 can be designed for amplifying and/or processing a sound signal contained in the detected sound waves. The sound signal can encompass, for example, speech, tones, and/or music. The sound signal therefore encompasses audible sound waves or encompasses an electrical signal, which comprises the audible sound waves.

The other microphone amplifier 9, 10 can be designed for amplifying and/or processing a distance signal contained in the detected sound waves. Since the MEMS sound transducer 2 emits ultrasonic waves in order to determine the distance A, the detected sound waves likewise comprise ultrasonic waves, on the basis of which the distance 5 is determined. The microphone amplifier 9, 10 mentioned here can therefore amplify and/or process the ultrasonic waves contained in the detected sound waves.

Furthermore, the loudspeaker unit 1 can comprise at least one processor 11, 12. With the aid of the at least one processor 11, 12, the acoustic signals, in particular the sound signals and/or the distance signal, can be processed. The acoustic signals can be, for example, digitized and/or filtered by the at least one processor 11, 12.

According to the present exemplary embodiment from FIG. 1, the loudspeaker unit 1 comprises two processors 11, 12. The first processor 11 can be connected downstream from the first microphone amplifier 9. The acoustic signal processed or amplified by the first microphone amplifier 9, in particular the sound signal, can therefore be conducted to the first processor 11. The second processor 12 can be connected downstream from the second microphone amplifier 10. The acoustic signal processed or amplified by the second microphone amplifier 10, in particular the distance signal, can therefore be conducted to the second processor 12.

The loudspeaker unit 1 advantageously comprises at least one input 13, via which, for example, an audio signal for generating corresponding sound waves can be supplied to the MEMS sound transducer 2.

Additionally or alternatively, it is advantageous if the loudspeaker unit 1 comprises at least one output 14, 15. The loudspeaker unit 1 according to the present exemplary embodiment comprises two outputs 14, 15. The first output 14 is connected to the first processor 11 and is connected via the first processor 11 to the first microphone amplifier 9. Alternatively, the first output 14 can also be directly connected to the first microphone amplifier 9. The sound signal can therefore be output via the first output 14. The sound signal can therefore be, for example, stored or relayed. The sound signal can then be sent, for example, to a conversation partner, when the loudspeaker unit 11 is arranged in a smartphone or a telephone and is utilized for this purpose.

In addition, the loudspeaker unit 1 comprises the second outlet 15, via which the distance signal can be conducted out of the loudspeaker unit 1. The distance signal can then be conducted to a further unit. The distance signal can be further processed, for example, in the smartphone. An evaluation unit (not shown here), which evaluates the distance signal, can also be arranged downstream from the second output 15.

In addition, the loudspeaker unit 1 according to the present exemplary embodiment comprises a switching unit 7, with the aid of which a connection can be established between the MEMS sound transducer 2 and the processing unit 6. Furthermore, in the present exemplary embodiment, a connection can be established between the MEMS sound transducer 2 and the loudspeaker amplifier 8 and/or the first microphone amplifier 9 and/or the second microphone amplifier 10 with the aid of the switching unit 7. Alternatively, a connection can also be established between the MEMS sound transducer 2 and the first processor 11 and/or the second processor 12.

According to the present exemplary embodiment, the switching unit 7 comprises at least one switch 16-18, with the aid of which a connection can be established between the MEMS sound transducer 2 and the processing unit 6. The switching unit 7 from FIG. 1 comprises three switches 16-18.

In the present exemplary embodiment, a connection can be established between the MEMS sound transducer 2 and the loudspeaker amplifier 8 with the aid of the first switch 16, so that the audio signal can be conducted to the MEMS sound transducer 2 for output.

Additionally or alternatively, the switching unit 7 comprises a second switch 17, with the aid of which, in the present exemplary embodiment, a connection can be established between the MEMS sound transducer 2 and the first microphone amplifier 9. Additionally or alternatively, a connection can also be established between the MEMS sound transducer 2 and the first processor 11 with the aid of the second switch 17

Additionally or alternatively, the switching unit 7 comprises a third switch 18, with the aid of which, in the present exemplary embodiment, a connection can be established between the MEMS sound transducer 2 and the second microphone amplifier 10. Additionally or alternatively, a connection can also be established between the MEMS sound transducer 2 and the second processor 12 with the aid of the third switch 18.

The three switches 16-18 from the present exemplary embodiment can be opened and closed independently of one another. This means, only one switch 16-18 can be closed at any time, while the other two are open. Alternatively, two switches 16-18 can also be closed, wherein the respective remaining switch 16-18 is open, or all three switches 16-18 can also be closed. Alternatively, all three switches 16-18 can also be open.

Furthermore, the loudspeaker unit 1 can comprise a control unit 29. According to the present exemplary embodiment, the control unit 29 can be connected to the switching unit 7. Additionally or alternatively, as shown in the present exemplary embodiment, the control unit 29 can also be connected to the processing unit 6. The control unit 29 can switch, for example, at least one of the switches 16-18 of the switching unit 7. Additionally or alternatively, the control unit 29 can also control the loudspeaker amplifier 8, at least one of the microphone amplifiers 9, 10, and/or at least one processor 11, 12 of the processing unit.

In addition, the loudspeaker unit 1 of the present exemplary embodiment comprises an evaluation unit 30. With the aid of the evaluation unit 30, the distance A, a change over time of the distance A, and/or a distance profile can be evaluated, for example, in order to be able to recognize gestures or a shape of the object 5. As a result, for example, swiping movements can be detected with the aid of the MEMS sound transducer 2, so that an appropriate action is carried out. For example, a smartphone can be activated with the aid of the swiping movement when the loudspeaker unit 1 and the MEMS sound transducer 2 are arranged in a smartphone.

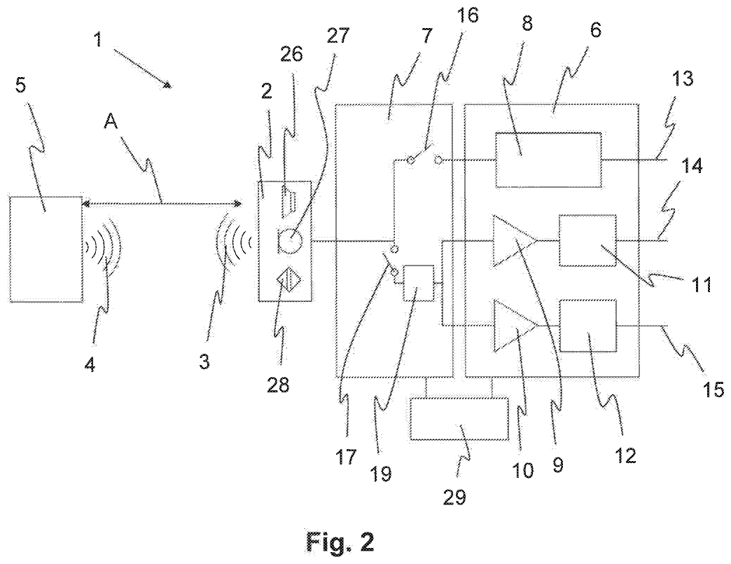

FIG. 2 shows a block diagram of a loudspeaker unit 1 according to an alternative exemplary embodiment. For the sake of simplicity, the features that are similar to those from FIG. 1 will not be discussed once more.

According to the present exemplary embodiment, the switching unit 7 of the loudspeaker unit 1 comprises at least one switch 16, 17 and a frequency-separating filter 19. The first switch 16 connects the MEMS sound transducer 2 to the loudspeaker amplifier 8, so that the audio signal intended for output, which can be amplified and/or processed by the loudspeaker amplifier 8, can be conducted to the MEMS sound transducer 2.

A connection can be established between the MEMS sound transducer 2 and the frequency-separating filter 19 with the aid of the second switch 17. Furthermore, the frequency-separating filter 19 is connected to the first microphone amplifier 9 and to the second microphone amplifier 10, so that the acoustic signal detected by the MEMS sound transducer 2 can be conducted, via the frequency-separating filter 19, to the two microphone amplifiers 9, 10. The frequency-separating filter 19 can be designed in such a way that the sound signal, which has frequencies in the audible wavelength spectrum, is conducted to the first microphone amplifier 9, and the distance signal, which has frequencies in the ultrasonic range, is conducted to the second microphone amplifier 10. For this purpose, the frequency-separating filter 19 can comprise, for example, an array of high-pass filters, low-pass filters, and/or band-pass filters. As a result, starting from the acoustic signal, the sound signal and the distance signal can be separated from one another in a simple way.

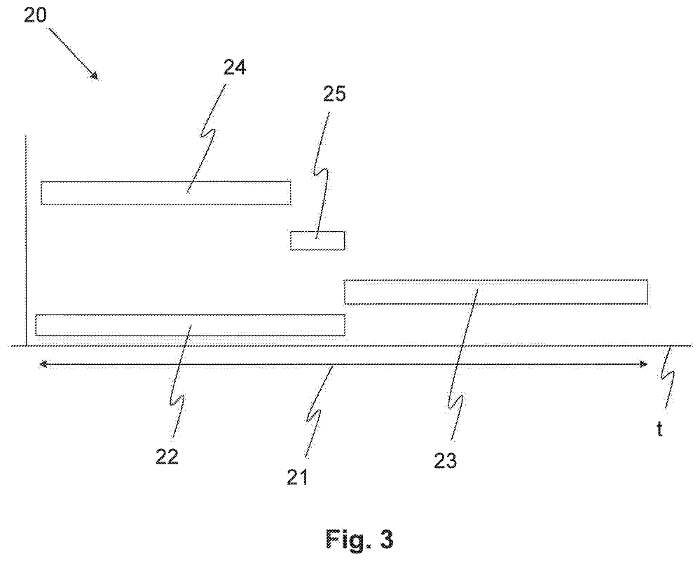

FIG. 3 schematically shows a timing diagram 20 of operating conditions of the loudspeaker unit 1. The time t is plotted on the x-axis, and durations of the various intervals are plotted along the y-axis,

The timing diagram 20 has a period 21, which can represent a cycle time, according to which the loudspeaker unit 1 can be operated. The period 21 can repeat and can have a constant duration. For example, the period 21 can last for between 0.1 μs and 10 ms. Alternatively, the period can also last for between 0.5 μs and 5 ms. The duration of a period 21 can be constant or variable in this case. For example, two consecutive periods 21 can have different durations.

Furthermore, a period 21 can be subdivided into a loudspeaker interval 22 and a microphone interval 23. In the present timing diagram from FIG. 3, the microphone interval 23 follows the loudspeaker interval 22. Alternatively, however, the loudspeaker interval 22 can also follow the microphone interval 23.

In the loudspeaker interval 22, the loudspeaker unit 1 is operated as a loudspeaker 26. This means, during the loudspeaker interval 22, the MEMS sound transducer 2 is operated in order to generate sound waves 3. Therefore, sounds, tones, and speech can be generated during the loudspeaker interval 22. In addition, the ultrasonic waves for measuring the distance A can be generated during the loudspeaker interval 22. Advantageously, the MEMS sound transducer 2 can be connected to the loudspeaker amplifier 8 during the loudspeaker interval 22, so that the audio signal intended for output by the MEMS sound transducer 2 can be conducted to the MEMS sound transducer 2. The audio signal can be processed and/or amplified with the aid of the loudspeaker amplifier 8.

In the microphone interval 23, the loudspeaker unit 1 can be operated in such a way that sound waves can be detected. During the microphone interval 23, the MEMS sound transducer 2 can therefore be operated in such a way that sound waves from the surroundings of the loudspeaker unit 1 can be detected. The MEMS sound transducer 2 is operated as a microphone 27 in the microphone interval 23. The detected sound waves can be conducted, for example, in the form of the acoustic signal, to at least one microphone amplifier 9, 10. The acoustic signal can be amplified and/or processed with the aid of the at least one microphone amplifier 9, 10. In order to conduct the acoustic signal to the at least one microphone amplifier 9, 10, the switching unit 7 can switch accordingly. For example, the second switch 17 and/or the third switch 18 can be closed in order to conduct the acoustic signal to the appropriate microphone amplifier 9, 10, respectively. During the microphone interval 23, the ultrasonic waves reflected by the object 5 can also be detected and conducted to the appropriate microphone amplifier 9, 10.

According to the present exemplary embodiment of the method for operating the loudspeaker unit 1, the loudspeaker interval 22 can encompass a sound interval 24 and an ultrasound interval 25. The ultrasound interval 25 follows the sound interval 24. Alternatively, the ultrasound interval 25 can also be arranged first and the sound interval 24 can follow it with respect to time.

During the sound interval 24, the MEMS sound transducer 2 can be operated in such a way that sound waves are generated in the range of the audible wave spectrum, such as music, tones, and/or speech. During the ultrasound interval 25, the MEMS sound transducer 2 can be operated in such a way that ultrasonic waves and/or the ultrasonic signal are/is generated in order to measure the distance A between the object 5 and the MEMS sound transducer 2.

It is advantageous if the microphone interval 23 follows the ultrasound interval 25. As a result, the ultrasonic waves emitted during the ultrasound interval 25 and sound waves 4 reflected on the object 5 can be detected during the microphone interval 23. The distance A between the MEMS sound transducer 2 and the object 5 can be determined from the time lag between the emission of the ultrasonic waves and the detection of the sound waves 4 reflected on the object 5.

Alternatively, the ultrasonic waves can also be modulated onto the sound waves in the audible wavelength range. The ultrasonic waves are therefore modulated onto the music, onto the tones, and/or onto the speech. Since the ultrasonic waves have higher frequencies than the music, the tones, and/or the speech, this does not adversely affect the sound quality of the music, the tones, and/or the speech. As a result, the ultrasonic waves can be generated simultaneously with the sound waves of the audible wavelength range during the loudspeaker interval 22.

The present invention is not limited to the represented and described exemplary embodiments. Modifications within the scope of the claims are also possible, as is any combination of the features, even if they are represented and described in different exemplary embodiments.

### LIST OF REFERENCE NUMERALS

1 loudspeaker unit

2 MEMS sound transducer

3 generated sound waves

4 reflected sound waves

5 object

6 processing unit

7 switching unit

8 loudspeaker amplifier

9 first microphone amplifier

10 second microphone amplifier

11 first processor

12 second processor

13 input

14 first output

15 second output

16 first switch

17 second switch

18 third switch

19 frequency-separating filter

20 timing diagram

21 period

22 loudspeaker interval

23 microphone interval

24 sound interval

25 ultrasound interval

26 loudspeaker

27 microphone

28 ultrasonic proximity sensor

29 control unit

30 evaluation unit

A distance

t time

What is claimed is:

1. A method for operating a loudspeaker unit for a portable device, in which sound waves in the audible wavelength range are generated and/or detected with the aid of a control unit for operating a MEMS sound transducer of the loudspeaker unit, the method comprising the steps of:
generating ultrasonic waves from the MEMS sound transducer and directing the ultrasonic waves at an object at a first time recorded by the control unit;
detecting ultrasonic waves reflected from the object at a second time recorded by the control unit;
wherein the control unit uses the time duration between the first time and the second time to measure a distance between the MEMS sound transducer and the object.

2. The method as claimed in claim 1, wherein the ultrasonic waves generated from the MEMS sound transducer forms a haptic perception.

3. The method as claimed in claim 1, further comprising the steps of:
operating the MEMS sound transducer as a loudspeaker during a loudspeaker interval;
operating the MEMS sound transducer as a microphone during a microphone interval, which is time-shifted with respect to the loudspeaker interval; and
wherein the microphone interval is time-shifted with respect to the loudspeaker interval so that the microphone interval and the loudspeaker interval do not completely overlap.

4. The method as claimed in claim 3, wherein the loudspeaker unit includes at least one loudspeaker amplifier, which processes an audio signal and sends the audio signal to the MEMS sound transducer at least during the loudspeaker interval.

5. The method as claimed in claim 3, wherein the loudspeaker unit includes at least one microphone amplifier, which at least during the microphone interval receives an acoustic signal from the MEMS sound transducer and processes the acoustic signal.

6. The method as claimed in claim 5, further comprising the steps of:
operating the MEMS sound transducer to generate ultrasound waves during an ultrasound interval;
wherein during the loudspeaker interval, the MEMS sound transducer generates audible sound waves in a sound interval that is time-shifted with respect to the ultrasound interval; and
wherein the sound interval and the ultrasound interval alternate at least once.

7. The method as claimed in claim 6, wherein the ultrasonic waves are used by the control unit for measuring the distance between the MEMS sound transducer and the object and wherein the ultrasonic waves and the sound waves of the audible wavelength range are generated simultaneously.

8. The method as claimed in claim 7, wherein a sound signal contained in the acoustic signal is received and amplified by a first microphone amplifier, and a distance signal contained in the acoustic signal is received and amplified by a second microphone amplifier.

9. The method as claimed in claim 8, further comprising the steps of:
filtering the sound signal out of the acoustic signal with a frequency-separating filter in the loudspeaker unit;
sending the sound signal to the first microphone amplifier;
filtering the distance signal out of the acoustic signal with the frequency-separating filter in the loudspeaker unit; and
sending the distance signal to the second microphone amplifier.

10. The method as claimed in claim 9, further comprising the steps of:
conducting the sound signal from the first microphone amplifier to a first processor, which digitizes and/or filters the sound signal; and
conducting the distance signal from the second microphone amplifier to a second processor, which digitizes and/or filters the distance signal.

11. The method as claimed in claim 8, further comprising the steps of:
having the control unit control a switching unit of the loudspeaker unit in such a way that a connection is established between the loudspeaker amplifier and the MEMS sound transducer during the loudspeaker interval and a connection is established between the MEMS sound transducer and the at least one microphone amplifier during the microphone interval.

12. The method as claimed in claim 8, further comprising the steps of:
having the control unit control a switching unit of the loudspeaker unit in such a way that a connection is established between the loudspeaker amplifier and the MEMS sound transducer during the loudspeaker interval or a connection is established between the MEMS sound transducer and the at least one microphone amplifier during the microphone interval.

13. The method as claimed in claim 3, wherein a combined duration of the loudspeaker interval and the microphone interval lasts for between 0.5 μs and 5 ms, and the duration of the loudspeaker interval has a ratio with respect to the duration of the microphone interval between 50 and 2500.

14. The method as claimed in claim 3, wherein a combined duration of the loudspeaker interval and the microphone interval lasts for between 0.5 μs and 5 ms, and the duration of the loudspeaker interval is substantially the same as the duration of the microphone interval.

15. The method as claimed in claim 6, wherein the duration of the sound interval with respect to the duration of the ultrasound interval has a ratio between 50 and 2500.

16. The method as claimed in claim 8, further comprising the steps of:
using an evaluation unit to evaluate the distance signal and determine a distance profile.

17. The method as claimed in claim 8, further comprising the steps of:
using an evaluation unit to evaluate the distance signal and determine a distance profile; and
using the evaluation unit to evaluate the distance profile so that gestures are recognized.

18. A loudspeaker unit for a portable device, the loudspeaker unit comprising:
a MEMS sound transducer and configured for generating and/or detecting acoustic waves in the audible wavelength range;
a control unit connected to the MEMS sound transducer and configured for operating the MEMS sound transducer as an ultrasonic proximity sensor;
wherein the MEMS sound transducer is further configured for generating and/or detecting ultrasonic waves.

19. The method as claimed in claim 3, wherein a combined duration of the loudspeaker interval and the microphone interval lasts for between 0.1 μs and 20 ms, and the duration of the loudspeaker interval has a ratio with respect to the duration of the microphone interval between 10 and 5000.

20. The method as claimed in claim 6, wherein the duration of the sound interval with respect to the duration of the ultrasound interval has a ratio between 10 and 5000.
